(19) United States
(12) Patent Application Publication
(10) Pub. No.: US 2008/0217251 A1
(43) Pub. Date: Sep. 11, 2008

(54) METHOD OF PURIFYING IMMERSION OIL

(75) Inventor: Toshiro ITANI, Ibaraki (JP)

Correspondence Address: YOUNG & THOMPSON, 209 Madison Street, Suite 500, ALEXANDRIA, VA, 22314, US

(73) Assignee: NEC ELECTRONICS CORPORATION, KANAGAWA (JP)

(21) Appl. No.: 12/043,985

(22) Filed: Mar. 7, 2008

(30) Foreign Application Priority Data
Mar. 7, 2007 (JP) 2007-057783

(51) Int. Cl. B01D 15/00

(52) U.S. Cl. 210/660

(57) ABSTRACT

A method of purifying immersion oil, includes bringing a liquid organic compound into contact with a solid base, wherein the solid base is barium oxide.

This application is based on Japanese patent application No. 2007-057783, the content of which is incorporated hereinto by reference.

### BACKGROUND

1. Technical Field

The present invention relates to a method of purifying immersion oil to be used for an immersion type projection exposure equipment.

2. Related Art

For manufacturing semiconductor chips or the like, step-and-repeat type reduction projection exposure equipments (steppers) have been dominantly employed conventionally, among the projection exposure equipments. These days, however, step-and-scan type projection exposure equipments, which synchronically scan the reticle and the wafer for exposure, have come to be focused on.

The resolution of the projection optical system included in the projection exposure equipment can be increased by reducing the exposure wavelength employed thereby, and increasing the numerical aperture of the projection optical system. Accordingly, concurrently with the micronization of the semiconductor chips, the exposure wavelength utilized in the projection exposure equipment is becoming shorter year after year, and the numerical aperture of the projection optical system is also increasing. Although the exposure wavelength dominantly employed at present is 248 nm of KrF excimer laser, an even shorter wavelength such as 193 nm of ArF excimer laser has already been put to practical use.

Only limited glass materials have such transmittance that allows securing a sufficient light amount for the exposure, without compromise in desired image forming performance that would be achieved by shortening the wavelength of the exposure light. Accordingly, for example JP-A No. H10-303114 discloses an immersion type projection exposure equipment that includes liquid such as water or an organic solvent loaded in a region between a lower end portion of the projection optical system and the surface of a wafer. Since the wavelength of the exposure light is reduced in liquid to 1/n times (n denotes the refractive index of the liquid, which is normally 1.2 to 1.6) of the wavelength thereof in the air, substituting the air present between the lower end portion of the projection optical system and the wafer surface with liquid, instead of shortening the exposure wavelength, enables improving the resolution.

Mandatory requirements of the liquid to be loaded in the region between the lower end portion of the projection optical system of the projection exposure equipment and the wafer surface include sufficiently low optical absorbance that assures that the route of the light substantially remains unchanged in all the optical paths, and high photochemical stability that suppresses fluctuation of optical characteristics such as optical absorbance during the practical use. Further, a sufficiently high refractive index at the employed exposure wavelength is also required.

Prior art related to the present invention includes JP-A No. 2006-222186, in addition to JP-A No. H10-303114.

[Patent document 1] JP-A No. H10-303114

[Patent document 2] JP-A No. 2006-222186

The liquid conventionally known to have the high refractive index required from the immersion liquid includes a sugar and a saturated alicyclic hydrocarbon compound. Such compounds have, however, a drawback that the optical absorbance becomes excessively high, especially in a wavelength range not longer than 250 nm, and are hence inappropriate for use as the immersion solution.

### SUMMARY

Through persistent studies, the present inventor has discovered, based on comparison in absorbing spectrum and refractive index of organic compounds that are liquid at a room temperature, between before and after purification by contacting the compounds with a solid base, that the organic compounds brought into contact with the solid base exhibits a lower optical absorbance in the wavelength range not longer than 250 nm, than those not brought into contact therewith, while maintaining the refractive index unchanged. The present invention has been achieved based on such finding.

In one embodiment, there is provided a method of purifying immersion oil, comprising bringing a liquid organic compound into contact with a solid base, wherein the solid base is barium oxide. The method thus arranged enables obtaining the immersion oil that exhibits sufficiently low optical absorbance in the wavelength range not longer than 250 nm.

Thus, the present invention provides a method for purifying immersion oil having excellent characteristics as immersion solution.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereafter, an exemplary embodiment of the present invention will be described in details.

A method of purifying immersion oil according to the embodiment of the present invention includes a step of bringing a liquid organic compound into contact with a solid base. Herein, the solid base is barium oxide.

In the contacting step, it is preferable to bring the liquid organic compound not washed with sulfuric acid, into contact with the solid base. In other words, it is preferable not to perform the sulfuric acid washing process before contacting the liquid organic compound with the solid base.

According to this embodiment, the liquid organic compound is brought into contact with the solid base, thereby giving immersion oil having a sufficiently low optical absorbance in the wavelength range not longer than 250 nm, in addition to excellent photochemical stability and a high refractive index at the employed exposure wavelength. The barium oxide properly acts as the solid base for such purification. Consequently, in this embodiment, it is provided a method of purifying the immersion oil having excellent characteristics as immersion solution.

When a process of washing with the sulfuric acid is not conducted before contacting the liquid organic compound with the solid base, it leads to a decrease in number of steps for purifying the immersion oil. In the embodiment, since the liquid organic compound is brought into contact with the solid base, the immersion oil having satisfactory characteristics required as immersion solution can still be obtained despite omitting the sulfuric acid cleaning process.

Further, the present inventor has also discovered, through comparison in absorbing spectrum and refractive index of organic compounds that are liquid in room temperature, between before and after irradiating the compounds with an ultrasonic wave in room temperature, under atmospheric pressure and in ambient atmosphere, that the organic compound irradiated with the ultrasonic wave exhibits a lower optical absorbance in the wavelength range not longer than 250 nm, than those not irradiated with the ultrasonic wave, while maintaining the refractive index unchanged. It is preferable, therefore, that the method of purifying immersion oil according to this embodiment further includes irradiating the liquid organic compound with the ultrasonic wave. The irradiating step may be performed either before the contacting step or thereafter.

### EXAMPLE 1

The mixture of 2 g of barium oxide and 10 g of cyclohexanol was stirred by a magnetic stirrer in room temperature for two days. After the stirring, the mixture was filtrated through a membrane filter having a thickness of 3 μm, and resulted filtrate was measured for the optical absorption coefficient at 193 nm, the result being 1.576 cm⁻¹. The refractive index at 193 nm was also measured, the result being 1.647.

### COMPARATIVE EXAMPLE 1

The optical absorption coefficient of the cyclohexanol at 193 nm was measured, the result being 1.616 cm⁻¹. The refractive index thereof at 193 nm was also measured, the result being 1.647.

Upon comparing the Example 1 with the comparative example 1, it is understood that contacting the cyclohexanol with the barium oxide led to improved transparency of the cyclohexanol, while the refractive index remained unchanged.

### EXAMPLE 2

The mixture of 2 g of barium oxide and 10 g of D-cyclohexanol (C6D110D) was stirred by a magnetic stirrer in room temperature for two days. After the stirring, the mixture was filtrated through a membrane filter having a thickness of 3 μm, and the resulted filtrate was measured for optical absorption coefficient at 193 nm, the result being 0.446 cm⁻¹. The refractive index thereof at 193 nm was also measured, the result being 1.665.

### COMPARATIVE EXAMPLE 2

The optical absorption coefficient of the D-cyclohexanol at 193 nm was measured, the result being 0.494 cm⁻¹. The refractive index thereof at 193 nm was also measured, the result being 1.665.

Upon comparing the working example 2 with the comparative example 2, it is understood that contacting the D-cyclohexanol with barium oxide led to improved transparency of the D-cyclohexanol, while the refractive index remained unchanged.

### EXAMPLE 3

To a glass container, 10 g of cyclohexanol was charged, and was irradiated with an ultrasonic wave under atmospheric pressure and in ambient atmosphere for two hours, by using an ultrasonic cleaner No. 3200 from Branson Ultrasonics Corporation. The ultrasonicated cyclohexanol was measured for an optical absorption coefficient of the cyclohexanol at 193 nm, the result being 1.458 cm⁻¹. The refractive index thereof at 193 nm was also measured, the result being 1.647.

Upon comparing the working example 3 with the comparative example 1, it is understood that irradiating the cyclohexanol with the ultrasonic wave led to improved transparency of the cyclohexanol, while the refractive index remained unchanged.

It should be noted that the measurement of the optical absorbance may be performed as follows. A vacuum UV (VUV) spectrometer, equipped with a hydrogen vapor lamp and a chromo-iridium grid of 1200 lines/mm capable of measuring the transmittance and reflection in a wavelength range of 100 to 250 nm in a resolution of 0.5 nm, is prepared for operation in a vacuum.

The specimen is placed into a sealed aluminum cell with two CaF₂ windows divided by a PTFE spacer of 25 μm to 2 mm in thickness. Then the measurement is performed based on a double ray technique that allows correcting possible fluctuation in intensity of the lamp. The value of the optical absorbance may be obtained by subtracting from the experimental measurement value the optical absorbance of the window, which can be obtained from the empty cell. The accuracy of the transmittance measurement is in the order of 5%. The optical absorption coefficient A [cm⁻¹] may be calculated by the following equation.

A=log₁₀(T)/s (1)

In this equation, T represents the transmittance (ratio of emitted light intensity with respect to incident light intensity), and s the thickness [cm] of the spacer dividing the window. Here, the optical absorbance is denoted as 0.434 sA.

For the measurement, the specimen is kept in room temperature, and then cooled by liquid nitrogen so as to degas the specimen carefully operating a mechanical pump (10⁻³ mbar) in vacuum, thereby removing the dissolved gas. The degassed specimen is reserved in a small glass bottle with an air-tight Rotaflo stopcock. The measurement cell is then loaded and air-tightly enclosed in a dry box in which nitrogen is supplied, so as to keep air from the specimen from being absorbed.

The present invention is not limited to the foregoing embodiment and the working examples, but various modifications may be made. The immersion oil obtained according to the present invention may be appropriately employed as immersion solution for an immersion type projection exposure equipment, used for transferring a mask pattern to a photosensitive substrate, in a lithography process for fabricating a device such as a semiconductor chip, an imaging device (CCD or the like), an LCD device, or a thin-film magnetic head.

It is apparent that the present invention is not limited to the above embodiment, and may be modified and changed without departing from the scope and spirit of the invention.

What is claimed is:

1. A method of purifying immersion oil, comprising:
bringing a liquid organic compound into contact with a solid base;
wherein said solid base is barium oxide.

2. The method according to claim 1,
wherein said bringing a liquid organic compound into contact with a solid base includes bringing a liquid organic compound not washed with sulfuric acid into contact with a solid base.

3. The method according to claim 2, further comprising:
irradiating said liquid organic compound with an ultrasonic wave.
